(19) United States
(12) Patent Application Publication
(10) Pub. No.: US 2018/0304702 A1
(43) Pub. Date: Oct. 25, 2018

(54) ON-BOARD DEVICE AND VEHICLE COMMUNICATION SYSTEM

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventors: Yusuke Urano, Yokkaichi, Mie (JP); Masaya Ina, Yokkaichi, Mie (JP)

(21) Appl. No.: 15/770,885

(22) PCT Filed: Nov. 2, 2016
(86) PCT No.: PCT/JP2016/082516

§ 371 Date: Apr. 25, 2018

(30) Foreign Application Priority Data
Nov. 6, 2015 (JP) 2015-218465

(51) Int. Cl. B60C 23/04; G07C 5/08; H04B 1/3822

(52) U.S. Cl. CPC B60C 23/0438; G07C 5/0808; G07C 2205/02; H04B 1/3822; G07C 5/085

(57) ABSTRACT

Provided is an on-board device and a vehicle communication system that can expand the transmission range of signals that are transmitted from transmission antennas of the on-board device. An on-board device transmits signals to a portable device, from a plurality of first to fourth LF transmission antennas that are provided for a vehicle at positions that are separate from each other. The on-board device includes a transmission unit that transmits the signals from the first to fourth LF transmission antennas such that a transmission range in which the portable device can receive the signals is a range around the vehicle. The transmission unit substantially simultaneously transmits the signals from two or more transmission antennas among the first to fourth LF transmission antennas, to expand the transmission range.

### CROSS-REFERENCE TO RELATED APPLICATIONS

This application is the U.S. national stage of PCT/JP2016/082516 filed Nov. 2, 2016, which claims priority of Japanese Patent Application No. JP 2015-218465 filed Nov. 6, 2015.

### TECHNICAL FIELD

The present disclosure relates to an on-board device that communicates with a portable device, and to a vehicle communication system.

### BACKGROUND

Vehicle communication systems that lock and unlock a vehicle door without using a mechanical key have come into practical use. Specifically, a keyless entry system, which allows a user to lock or unlock a vehicle door by performing a wireless remote operation using a portable device that belongs to the user, and a Smart Entry (registered trademark) system, which allows a user who owns the portable device to unlock a vehicle door by approaching the vehicle or holding a door handle, have come into practical use, for example.

In addition, a vehicle communication system that starts the engine of a vehicle without using a mechanical key has been put into practice. Specifically, a push-start system, which allows a user who owns a portable device, to start the engine upon the user simply pressing an engine start button, has been put into practice.

Furthermore, a welcome light system, which lights up an internal vehicle light or an external vehicle light when a user who owns a portable device approaches the vehicle, has come into practical use.

In such a vehicle communication system, the on-board device performs wireless communication with the portable device. The wireless communication is realized by: the on-board device transmitting various kinds of signals from transmission antennas thereof to the portable device, using radio waves in an LF (Low Frequency) band; and the portable device thus receiving the signals and transmitting response signals, using radio waves in a UHF (Ultra High Frequency) band. Upon performing authorization and checking the position of the portable device, the on-board device performs control to unlock a door, lock a door, start the engine, turn on a welcome light, and so on.

Here, signals transmitted from the on-board device are in the LF band, and the transmission range of the signals is limited to a predetermined range in the vicinity of the vehicle. In order to detect the position of the portable device with high accuracy, or swiftly detect the portable device approaching the vehicle, the signal reception sensitivity of the portable device may be set to be high. However, such a setting shortens the lifespan of the battery that drives the portable device.

JP 2015-113644A discloses technology for setting the reception sensitivity of the portable device to high sensitivity upon determining that the portable device is present in the cabin of the vehicle or at a distance that is no longer than a predetermined distance from the vehicle, and setting the reception sensitivity of the portable device to low sensitivity upon determining that the portable device is not present in the cabin of the vehicle nor at a distance that is no longer than the predetermined distance from the vehicle.

However, according to JP 2015-113644A, the reception sensitivity of the portable device remains low until the portable device approaches the vehicle. Therefore, it is not possible to swiftly detect the portable device approaching the vehicle.

In addition, if it is erroneously determined that the portable device is not present at a distance that is no longer than the predetermined distance from the vehicle, there is a problem in which accuracy in detecting the position of the portable device decreases because the reception sensitivity of the portable device is in a low sensitivity state.

An objective of the present disclosure is to provide an on-board device and a vehicle communication system that can expand the transmission range of signals that are transmitted from transmission antennas of the on-board device.

### SUMMARY

An on-board device according to one aspect of the present disclosure is an on-board device that transmits signals to a portable device, from a plurality of transmission antennas that are provided for a vehicle at positions that are separate from each other. The on-board device includes a transmission unit that transmits the signals from the transmission antennas such that a transmission range in which the portable device can receive the signals is a range around the vehicle. The transmission unit substantially simultaneously transmits the signals from two or more transmission antennas from among the transmission antennas, to expand the transmission range.

A vehicle communication system according to one aspect of the present disclosure includes: the on-board device; a plurality of transmission antennas that are provided for a vehicle at positions that are separate from each other; a portable device that receives the signals transmitted from the on-board device, and transmits a response signal corresponding to the signals thus received. The on-board device includes a reception unit that receives the response signal transmitted from the portable device, and executes processing corresponding to the response signal thus received.

Note that the present application is realized not only as an on-board device that includes the characteristic processing unit and transmission unit, but also as a signal transmission method that includes steps of such characteristic processing, or a program for causing a computer to execute such steps, for example. Also, the present application may be realized as a semiconductor integrated circuit that realizes part or all of the on-board device, or another system that includes the on-board device, for example.

With the above-described configurations, it is possible to provide an on-board device and a vehicle communication system that can expand the transmission range of signals that are transmitted from transmission antennas of the on-board device.

### BRIEF DESCRIPTION OF DRAWINGS

FIG. 1 is a schematic diagram showing an example of a configuration of a vehicle communication system according to an embodiment illustrated and described herein.

FIG. 2 is a block diagram showing an example of a configuration of an on-board device.

FIG. 3 is a block diagram showing an example of a configuration of a detection device.

FIG. 4 is a block diagram showing an example of a configuration of a portable device.

FIG. 5 is a flowchart showing processing procedures that are performed by the on-board device and the portable device.

FIG. 6 is a conceptual diagram showing a transmission range of signals that are transmitted from the on-board device according to the present embodiment.

FIG. 7 is a conceptual diagram showing a transmission range of signals that are transmitted from an on-board device according to a comparative example.

FIG. 8 is a conceptual diagram showing an experimental measurement system.

FIG. 9 is a chart showing results of measurement.

FIG. 10 is a graph showing the results of measurement.

FIG. 11 is a block diagram illustrating an example of a configuration of an on-board transmission unit according to a second embodiment.

FIG. 12 is a conceptual diagram showing a transmission range of signals that are transmitted from an on-board device according to the second embodiment.

FIG. 13 is a conceptual diagram showing a transmission range of signals that are transmitted from an on-board device according to a third embodiment.

FIG. 14 is a conceptual diagram showing a transmission range of signals that are transmitted from an on-board device according to a fourth embodiment.

### DETAILED DESCRIPTION OF PREFERRED EMBODIMENTS

First, embodiments of the present disclosure will be listed and described. At least some of the embodiments described may be combined as appropriate.

(1) An on-board device according to one aspect of the present disclosure is an on-board device that transmits signals to a portable device, from a plurality of transmission antennas that are provided for a vehicle at positions that are separate from each other. The on-board device includes a transmission unit that transmits the signals from the transmission antennas such that a transmission range in which the portable device can receive the signals is a range around the vehicle. The transmission unit substantially simultaneously transmits the signals from two or more transmission antennas from among the transmission antennas, to expand the transmission range.

According to this aspect, the transmission range of signals transmitted from one transmission antenna is a range around a vehicle, and the portable device when located outside the transmission range cannot receive the signals. Therefore, the transmission unit substantially simultaneously transmits signals from two or more transmission antennas. The signals that have been substantially simultaneously transmitted from two or more transmission antennas are superimposed on each other and have a larger amplitude. Therefore, it is possible to expand the transmission range of the signals transmitted from the transmission antennas of the on-board device.

(2) It is preferable to employ a configuration in which signals in an LF (Low Frequency) band are transmitted from the plurality of transmission antennas.

According to this aspect, the signals that are substantially simultaneously transmitted from the transmission antennas are signals in the LF band, and the amplitudes of the signals around the vehicle are uniform. That is, the wavelengths of the signals are long enough compared to the length of the range around the vehicle in which the portable device is to be detected, and phase shifting of the signals in the area around the vehicle does not have a significant influence. Therefore, the signals transmitted from the plurality of transmission antennas do not interfere with or weaken each other. The signals are simply superimposed on each other, and the amplitudes of the signals uniformly increase. Therefore, it is possible to expand the transmission range of the signals transmitted from the transmission antennas of the on-board device.

(3) It is preferable to employ a configuration in which at least two transmission antennas from among the transmission antennas are located at positions that are separate from each other in a front-rear direction or a left-right direction relative to a travelling direction of the vehicle, and the transmission unit substantially simultaneously transmits the signals from the two transmission antennas located at positions that are separate from each other in the front-rear direction or the left-right direction.

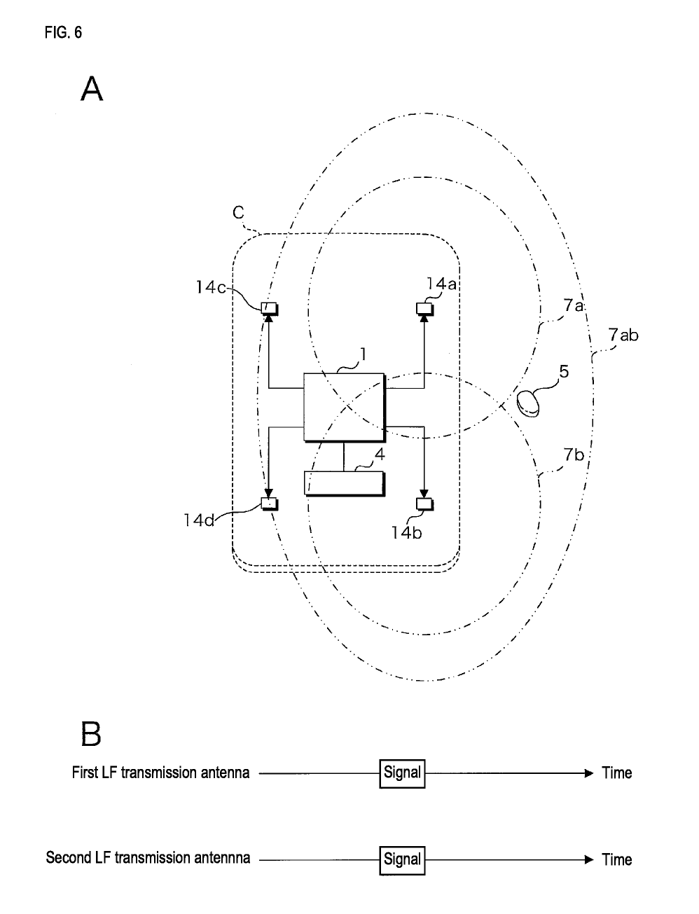

According to this aspect, if signals are substantially simultaneously transmitted from two transmission antennas located at positions that are separate from each other in the front-rear direction relative to the travelling direction of the vehicle, the transmission range of the signals mainly expands in a lateral direction of the vehicle (see FIG. 6).

Similarly, if signals are substantially simultaneously transmitted from two transmission antennas located at positions that are separate from each other in the left-right direction relative to the travelling direction of the vehicle, the transmission range of the signals mainly expands in the front-rear direction of the vehicle.

Note that, if signals are substantially simultaneously transmitted from a plurality of transmission antennas that are located at front, rear, left, and right positions relative to the travelling direction of the vehicle, the transmission range of the signals expands in the front-rear direction and the left-right direction of the vehicle.

(4) It is preferable to employ a configuration that includes a phase control unit that controls phases of the signals that are substantially simultaneously transmitted from the two transmission antennas.

According to this aspect, it is possible to control the direction in which the transmission range of the signals is expanded, by controlling the phases of the signals that are substantially simultaneously transmitted.

(5) It is preferable to employ a configuration in which the phase control unit alternatingly switches the signals to signals that are in phase and signals that are in antiphase, and signals that are in phase and signals that are in antiphase are alternatingly transmitted from the two transmission antennas.

According to this aspect, the signals that are substantially simultaneously transmitted are alternatingly switched to signals that are in phase and signals that are in antiphase, and the direction in which the transmission range of the signals expands changes over time. Thus, it is possible to expand the area in which communication can be performed with the portable device.

(6) It is preferable to employ a configuration in which the transmission unit substantially simultaneously transmits signals that are used to activate the portable device, from the two or more transmission antennas.

According to this aspect, it is possible to expand the transmission range of signals that are used to activate the portable device. Therefore, it is possible to activate a portable device that is more distant from the vehicle.

(7) It is preferable to employ a configuration in which the transmission unit substantially simultaneously transmits signals that are related to detection of a position of the portable device, from the two or more transmission antennas.

According to this aspect, it is possible to expand the transmission range of signals that are related to the detection of the position of the portable device. Therefore, it is possible to detect the position of a portable device that is more distant from the vehicle.

(8) It is preferable to employ a configuration in which the plurality of transmission antennas are respectively located at tire positions at which a plurality of tires of the vehicle are provided, and the transmission unit is provided for each of the plurality of tires, and the transmission units transmit the signals from the transmission antennas located at the tire positions, to a plurality of detection devices that wirelessly transmit air pressure signals obtained by detecting air pressure in the tires.

According to this aspect, the on-board device can communicate with the detection devices that detect the air pressure in the tires, and can also communicate with the portable device using the transmission antennas.

(9) A vehicle communication system according to one aspect of the present disclosure includes: the on-board device according to any one of aspects (1) to (8); a plurality of transmission antennas that are provided for a vehicle at positions that are separate from each other; a portable device that receives the signals transmitted from the on-board device, and transmits a response signal corresponding to the signals thus received. The on-board device includes a reception unit that receives the response signal transmitted from the portable device, and executes processing corresponding to the response signal thus received.

According to the present disclosure, as with aspect (1), it is possible to expand the transmission range of the signals transmitted from the transmission antennas of the on-board device. Therefore, the on-board device can wirelessly communicate with a portable device that is more distant, and can execute processing corresponding to the results of wireless communication.

The following describes specific examples of a vehicle communication system according to embodiments of the present disclosure with reference to the drawings. Note that the present disclosure is not limited to the examples, but is defined by the claims, and all modifications equivalent to and within the scope of the claims are intended to be encompassed.

### First Embodiment

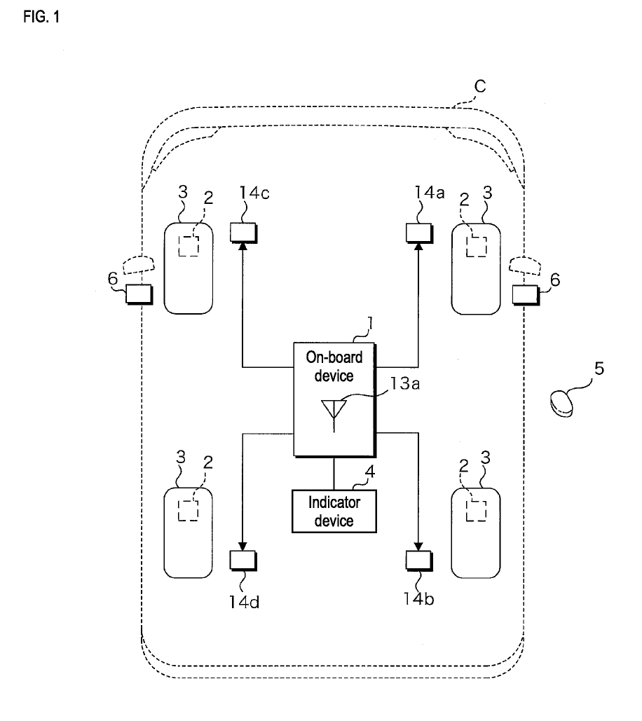

FIG. 1 is a schematic diagram showing an example of a configuration of a vehicle communication system according to an embodiment of the present disclosure. The vehicle communication system according to the present embodiment includes an on-board device 1 that is provided at an appropriate position of a vehicle body, a plurality of detection devices 2 that are respectively provided for the wheels of a plurality of tires 3 that are provided for a vehicle C, an indicator device 4, a portable device 5, and external vehicle illumination units 6, and constitutes a tire pressure monitoring system and a welcome light system.

A first LF transmission antenna 14a, a second LF transmission antenna 14b, a third LF transmission antenna 14c, and a fourth LF transmission antenna 14d are connected to the on-board device 1. The first to fourth LF transmission antennas 14a, 14b, 14c, and 14d are separately located at right-front, right-rear, left-front, and left-rear tire positions of the vehicle C, to which the four tires 3 are attached. The tire positions are positions corresponding to the wheel wells and the surroundings thereof, and at which the detection devices 2 provided for the tires 3 can individually receive signals respectively transmitted from the first to fourth LF transmission antennas 14a, 14b, 14c, and 14d.

In the vehicle communication system, when serving as a tire pressure monitoring system, the on-board device 1 transmits air pressure information request signals, which request information regarding the air pressure in the tires 3, to the detection devices 2, respectively from the first to fourth LF transmission antennas 14a, 14b, 14c, and 14d, using radio waves in the LF band. The detection devices 2 detect the air pressure in the tires 3 in response to the air pressure information request signals, and wirelessly transmit air pressure signals, which include the air pressure information thus detected and acquired and sensor identifiers of the detection devices 2, to the on-board device 1, using radio waves in the UHF band. The on-board device 1 is provided with an RF reception antenna 13a. Using the RF reception antenna 13a, the on-board device 1 receives air pressure signals transmitted from the detection devices 2, and acquires air pressure information regarding the tires 3 from the air pressure signals. The indicator device 4 is connected to the on-board device 1 via a communication line, and the on-board device 1 transmits the acquired air pressure information to the indicator device 4. The indicator device 4 receives the air pressure information transmitted from the on-board device 1, and indicates the air pressure information regarding each of the tires 3. Also, if the air pressure in a tire 3 is lower than a predetermined threshold, the indicator device 4 issues a warning.

On the other hand, in the vehicle communication system, when serving as a welcome light system, the on-board device 1 transmits signals that are used to detect the portable device 5 that is located in the vicinity of the vehicle C, to the portable device 5, respectively from the first to fourth LF transmission antennas 14a, 14b, 14c, and 14d, using radio waves in the LF band. The portable device 5 receives the signals transmitted from the first to fourth LF transmission antennas 14a, 14b, 14c, and 14d, and transmits a response signal corresponding to the received signals, to the on-board device 1, using radio waves in the UHF band. The on-board device 1 receives the response signal transmitted from the portable device 5, using the RF reception antenna 13a. Upon successfully authenticating the wireless communication through wireless communication with the portable device 5, the on-board device 1 turns on the external vehicle illumination units 6. The external vehicle illumination units 6 thus turned on brightly illuminate an area around the vehicle C to welcome the user.

Note that the LF band and the UHF band employed in the vehicle communication system according to the present embodiment are examples of radio wave bands that are used to perform wireless communication, and other radio wave bands may be employed.

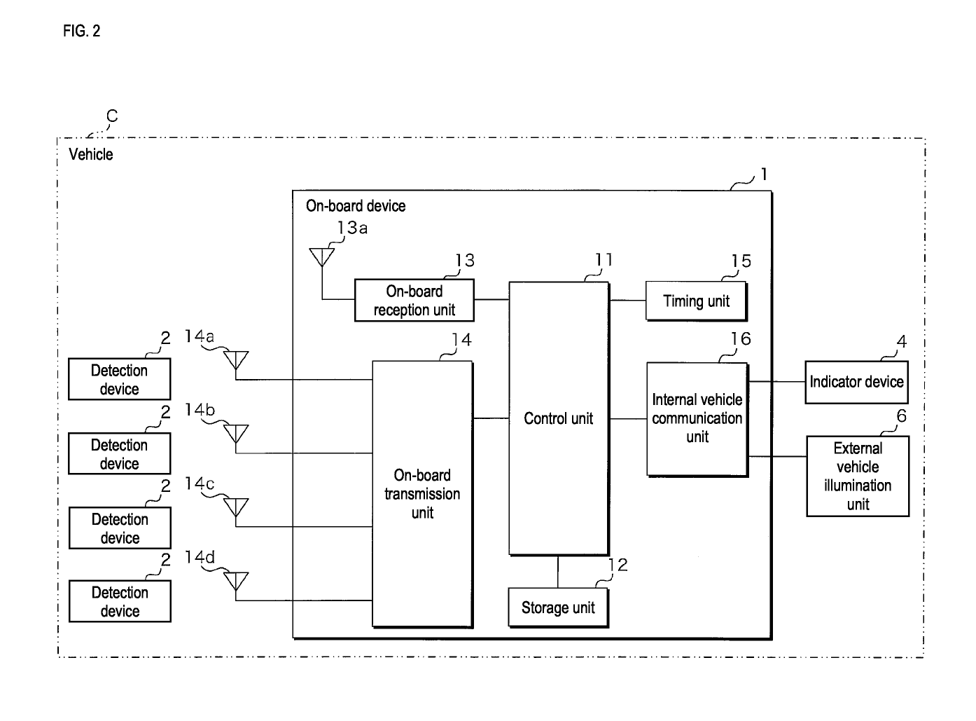

FIG. 2 is a block diagram showing an example of a configuration of the on-board device 1. The on-board device 1 includes a control unit 11 that controls operations of each constituent unit of the on-board device 1. A storage unit 12, an on-board reception unit 13, an on-board transmission unit 14, a timing unit 15, and an internal vehicle communication unit 16 are connected to the control unit 11.

The control unit 11 is, for example, a microcomputer that includes at least one CPU (Central Processing Unit), a multicore CPU, a ROM (Read Only Memory), a RAM (Random Access Memory), and an input/output interface, and so on. The CPU of the control unit 11 is connected to the storage unit 12, the on-board reception unit 13, the on-board transmission unit 14, the timing unit 15, and the internal vehicle communication unit 16 via the input/output interface. The control unit 11 executes a control program that is stored in the storage unit 12, to control operations of each constituent unit and execute processing related to the welcome light function and the air pressure monitoring function.

The storage unit 12 is a non-volatile memory such as an EEPROM (Electrically Erasable Programmable ROM) or a flash memory. The storage unit 12 stores a control program that enables the control unit 11 to control operations of each constituent component of the on-board device 1 to realize the welcome light function and the tire pressure monitoring function.

The RF reception antenna 13a is connected to the on-board reception unit 13. The on-board reception unit 13 receives signals transmitted from the portable device 5 or the detection devices 2 using radio waves in an RF band, via the RF reception antenna 13a. The on-board reception unit 13 is a circuit that demodulates the signals thus received, and outputs the demodulated signals to the control unit 11. Although carrier waves in the UHF band from 300 MHz to 3 GHz are employed here, carrier waves in another frequency band may be employed.

The first to fourth LF transmission antennas 14a, 14b, 14c, and 14d are connected to the on-board transmission unit 14. Each of the first to fourth LF transmission antennas 14a, 14b, 14c, and 14d includes: a rod-shaped magnetic core that is made of ferrite; and a coil that is wound around the outer circumferential surface of the magnetic core. Capacitors are respectively connected to the coils so as to form resonant circuits. The resonant circuits are connected to the on-board transmission unit 14. The on-board transmission unit 14 is a circuit that modulates signals output from the control unit 11 into signals in the LF band, and substantially simultaneously or individually transmits the modulated signals to the portable device 5 or the detection devices 2, from the first to fourth LF transmission antennas 14a, 14b, 14c, and 14d. The on-board transmission unit 14 feeds currents to the coils such that the transmission ranges of the signals transmitted from the first to fourth LF transmission antennas 14a, 14b, 14c, and 14d are included in a certain range around the vehicle, and thus signals are transmitted. The transmission ranges are ranges in which the portable device 5 can receive the signals. Although carrier waves in the LF band from 30 kHz to 300 kHz are used here, carrier waves in another frequency band may be employed.

In particular, the on-board transmission unit 14 is configured such that, when transmitting wake-up signals to activate the portable device 5, the on-board transmission unit 14 substantially simultaneously transmits the same wake-up signals from two or more transmission antennas among the first to fourth LF transmission antennas 14a, 14b, 14c, and 14d.

Also, the on-board transmission unit 14 is configured such that, when transmitting request signals to authenticate the portable device 5, the on-board transmission unit 14 substantially simultaneously transmits the same request signals from two or more transmission antennas among the first to fourth LF transmission antennas 14a, 14b, 14c, and 14d.

Furthermore, the on-board transmission unit 14 is configured such that, when transmitting detection signals to detect the position of the portable device 5, the on-board transmission unit 14 substantially simultaneously transmits the same detection signals from two or more transmission antennas among the first to fourth LF transmission antennas 14a, 14b, 14c, and 14d.

In contrast, the on-board transmission unit 14 is configured such that, when transmitting wake-up signals to activate the detection devices 2 of the tires 3, the on-board transmission unit 14 separately transmits the wake-up signals from the first to fourth LF transmission antennas 14a, 14b, 14c, and 14d.

Also, the on-board transmission unit 14 is configured such that, when transmitting air pressure information request signals to the detection devices 2, the on-board transmission unit 14 separately transmits the air pressure information request signals from the first to fourth LF transmission antennas 14a, 14b, 14c, and 14d.

Although the following mainly describes a case in which the signals that are substantially simultaneously transmitted from two or more transmission antennas among the first to fourth LF transmission antennas 14a, 14b, 14c, and 14d are the same signals, such a case is an example, and the signals are not necessarily exactly the same signals. Also, as long as the signals that are substantially simultaneously transmitted from two or more transmission antennas among the first to fourth LF transmission antennas 14a, 14b, 14c, and 14d are superimposed on each other and have a large amplitude, the signals may be out of phase. Furthermore, the signals transmitted from two or more transmission antennas among the first to fourth LF transmission antennas 14a, 14b, 14c, and 14d are not necessarily transmitted at exactly the same time, and it is only required that a period of time for which the signals are superimposed on each other and have a large amplitude is secured.

The timing unit 15 is constituted by a timer, a real-time clock, or the like, and starts time measurement under the control of the control unit 11, and supplies the result of time measurement to the control unit 11.

The internal vehicle communication unit 16 is a communication circuit that performs communication according to a communication protocol such as CAN (Controller Area Network) or LIN (Local Interconnect Network), and is connected to the indicator device 4 and the external vehicle illumination units 6. The internal vehicle communication unit 16 transmits air pressure information regarding the tires 3 to the indicator device 4, under the control of the control unit 11. Also, if the portable device 5 that is located in the vicinity of the vehicle C is detected, the internal vehicle communication unit 16 transmits lighting control signals to the external vehicle illumination units 6, under the control of the control unit 11.

The indicator device 4 is, for example, a display unit or an audio device provided with a speaker, which uses images or sounds to indicate air pressure information regarding the tires 3 transmitted from the internal vehicle communication unit 16, or a display unit that is provided in an indicator on an instrument panel. The display unit is a liquid crystal display, an organic EL display, a head-up display, or the like. For example, the indicator device 4 displays air pressure information regarding the tires 3 provided for the vehicle C.

Each external vehicle illumination unit 6 includes, for example, a light source that is provided on a door mirror or a door of the vehicle C, a driving circuit that supplies power to the light source to turn on the light source, and a reception circuit, that receives a lighting control signal transmitted from the internal vehicle communication unit 16. The external vehicle illumination units 6 turn on the light sources upon receiving the lighting control signals transmitted from the internal vehicle communication unit 16. The external vehicle illumination units 6 thus turned on illuminate an area around the vehicle C.

In the present embodiment, the external vehicle illumination units 6 that illuminate the outside of the vehicle are described as examples of lights that realize the welcome light function. However, lights that illuminate the inside of the vehicle may be employed.

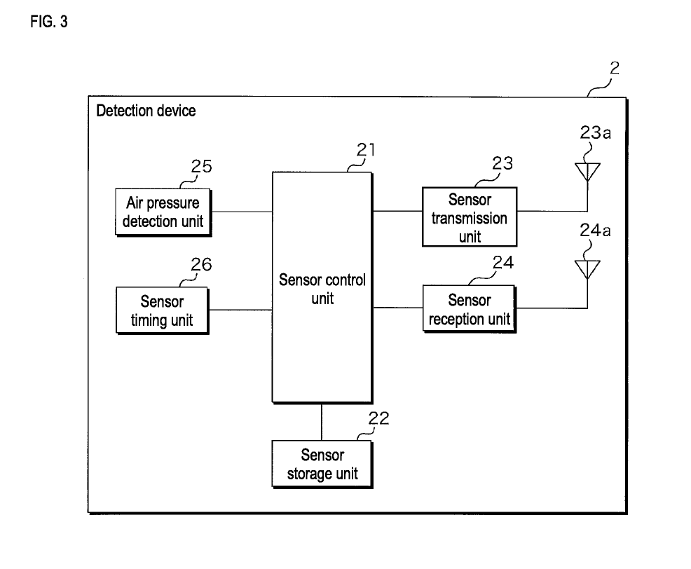

FIG. 3 is a block diagram showing an example of a configuration of a detection device 2. The detection device 2 includes a sensor control unit 21 that controls operations of each constituent unit of the detection device 2. A sensor storage unit 22, a sensor transmission unit 23, a sensor reception unit 24, an air pressure detection unit 25, and a sensor timing unit 26 are connected to the sensor control unit 21.

The sensor control unit 21 is, for example, a microcomputer that includes at least one CPU, a multicore CPU, a ROM, a RAM, an input/output interface, and so on. The CPU of the sensor control unit 21 is connected to the sensor storage unit 22, the sensor transmission unit 23, the sensor reception unit 24, the air pressure detection unit 25, and the sensor timing unit 26 via the input/output interface. The sensor control unit 21 reads out a control program that is stored in the sensor storage unit 22, and controls each unit. The detection device 2 is provided with a battery (not shown), and operates using power from the battery.

The sensor storage unit 22 is a non-volatile memory. The sensor storage unit 22 stores a control program that is used by the sensor control unit 21 to perform processing related to detection of the air pressure in the tire 3 and transmission of an air pressure signal. The sensor storage unit 22 also stores a unique sensor identifier that is used to distinguish the detection device 2 to which the sensor storage unit 22 belongs from other detection devices 2.

The air pressure detection unit 25 is provided with a diaphragm, for example, and detects the air pressure in the tire 3 based on the amount of deformation of the diaphragm that changes depending on the level of pressure. The air pressure detection unit 25 outputs a signal that indicates the detected air pressure in the tire 3, to the sensor control unit 21. The sensor control unit 21 executes a control program to acquire the air pressure in the tire 3 from the air pressure detection unit 25, generates an air pressure signal that includes air pressure information, a sensor identifier that is unique to the detection device 2, and so on, and outputs the air pressure signal to the sensor transmission unit 23.

Note that a temperature detection unit (not shown) that detects the temperature of the tire 3 and outputs a signal that indicates the detected temperature to the sensor control unit 21 may be provided. If this is the case, the sensor control unit 21 generates an air pressure signal that includes air pressure information, temperature information, the sensor identifier, and so on, and outputs the air pressure signal to the sensor transmission unit 23.

An RF transmission antenna 23a is connected to the sensor transmission unit 23. The sensor transmission unit 23 modulates the air pressure signal generated by the sensor control unit 21 into a signal in the UHF band, and transmits the modulated air pressure signal, using the RF transmission antenna 23a.

An LF reception antenna 24a is connected to the sensor reception unit 24. The sensor reception unit 24 receives, from the LF reception antenna 24a, an air pressure information request signal transmitted from the on-board device 1 using radio waves in the LF band, and outputs the received air pressure information request signal to the sensor control unit 21.

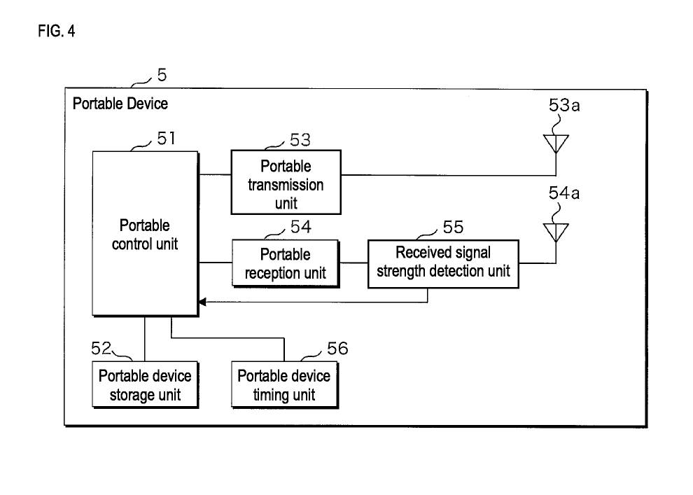

FIG. 4 is a block diagram showing an example of a configuration of the portable device 5. The portable device 5 includes a portable control unit 51 that controls operations of each constituent unit of the portable device 5. The portable control unit 51 is, for example, a microcomputer that includes at least one CPU, a multicore CPU, and so on. The portable control unit 51 is provided with a portable device storage unit 52, a portable transmission unit 53, a portable reception unit 54, and a portable device timing unit 56. The portable device 5 is provided with a battery (not shown), and operates using power from the battery.

The portable control unit 51 reads out a control program described below, which is stored in the portable device storage unit 52, to control operations of each constituent unit, thereby executing processing to check that an authorized portable device 5 is located in the vicinity of the vehicle C.

The portable control unit 51 has a dormant state in which power consumption is small and an active state in which power consumption is large. In a dormant state, upon the portable device 5 receiving a wake-up signal transmitted from the on-board device 1, the portable control unit 51 transitions from the dormant state to an active state, and starts operating. In an active state, after the portable control unit 51 has finished the required processing, if a predetermined period of time elapses without the portable device 5 receiving a signal from the on-board device 1, the portable control unit 51 transitions to a dormant state again.

The portable device storage unit 52 is a non-volatile memory that is similar to the storage unit 12. The portable device storage unit 52 stores a control program that enables the portable control unit 51 to control operations of each constituent unit of the portable device 5 to execute processing to check that an authorized portable device 5 is located in the vicinity of the vehicle C.

The portable transmission unit 53 is connected to an RF transmission antenna 53a, and transmits a response signal corresponding to a signal transmitted from the on-board device 1, under the control of the portable control unit 51. The portable transmission unit 53 transmits a response signal using radio waves in the UHF range. Note that the UHF band is an example of a radio wave band that is employed to transmit a signal, and another radio wave band may be employed.

The portable reception unit 54 is connected to an LF reception antenna 54a via a received signal strength detection unit 55. The portable reception unit 54 receives various kinds of signals transmitted from the on-board device 1 using radio waves in the LF band, and outputs the signals to the portable control unit 51. The LF reception antenna 54a is a three-axis antenna, for example, and is able to obtain received signal strength at a certain level regardless of the direction or the orientation of the portable device 5 relative to the vehicle C.

The received signal strength detection unit 55 is a circuit that detects the received signal strength of a signal received by the LF reception antenna 54a, especially, the received signal strength of a detection signal that is used to detect the position of the portable device 5, and outputs the received signal strength thus detected, to the portable control unit 51. The received signal strength is used to detect the position of the portable device 5 relative to the vehicle C.

The portable device timing unit 56 starts time measurement under the control of the portable control unit 51, and supplies the result of time measurement to the portable control unit 51. The portable device timing unit 56 is used to adjust the timing of transmitting a response signal.

### Welcome Light Function

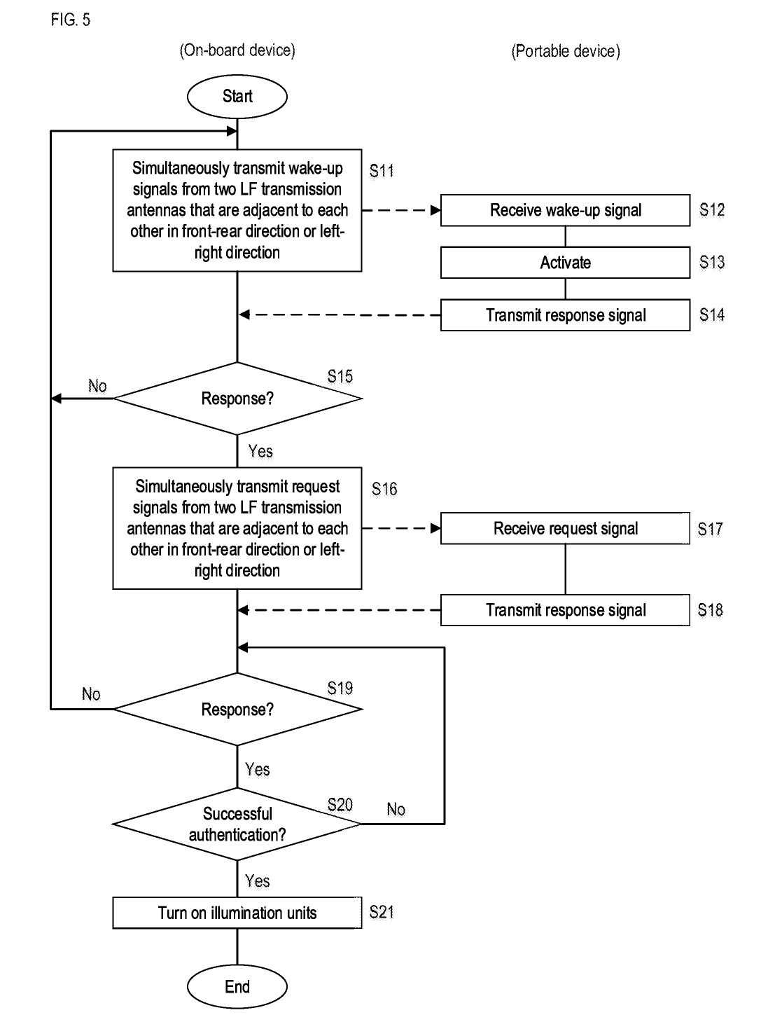

FIG. 5 is a flowchart showing processing procedures that are performed by the on-board device 1 and the portable device 5. The control unit 11 of the on-board device 1 operates when an ignition switch of the vehicle C is in an off state, and after the door is locked. First, the control unit 11 uses the on-board transmission unit 14 to substantially simultaneously transmit wake-up signals from two antennas that are adjacent to each other in the front-rear direction or the left-right direction relative to the travelling direction of the vehicle C, among the first to fourth LF transmission antennas 14a, 14b, 14c, and 14d (step S11). Wake-up signals are signals used to activate the portable device 5, and wake-up signals are periodically transmitted.

The portable device 5 monitors for externally transmitted signals even in a dormant state, and upon a wake-up signal being transmitted from the on-board device 1, the portable reception unit 54 receives the wake-up signal (step S12). The portable control unit 51 of the portable device 5 that has received the wake-up signal transitions from a dormant state to an active state (step S13), and then transmits a response signal that includes the identifier of the portable device 5 to the on-board device 1 using the portable transmission unit 53 (step S14).

The control unit 11 of the on-board device 1 that has transmitted the wake-up signal through processing in step S11 determines whether or not a response signal transmitted from the portable device 5 has been received by the on-board reception unit 13 within a predetermined waiting period (step S15). Upon determining that the response signal has not been received (step S15: NO), the control unit 11 returns processing to step S11.

Upon determining that the response signal has been received, (step S15: YES), the control unit 11 uses the on-board transmission unit 14 to substantially simultaneously transmit request signals from two antennas that are adjacent to each other in the front-rear direction or the left-right direction relative to the travelling direction of the vehicle C, among the first to fourth LF transmission antennas 14a, 14b, 14c, and 14d (step S16). Each request signal includes a first challenge code for authentication that has been generated using random numbers, the received identifier of the portable device 5, and so on.

The portable device 5 activated in step S13 waits in an active state for a predetermined period of time, and receives the request signal transmitted from the on-board device 1, using the portable reception unit 54 (step S17). Note that the portable control unit 51 determines whether or not the request signal is a request signal transmitted to the portable device 5 by determining whether or not the identifier included in the request signal matches the identifier of the portable device 5. If a predetermined period of time elapses without the portable device 5 receiving the request signal transmitted to the portable device 5, the portable control unit 51 transitions to a dormant state. The portable control unit 51 of the portable device 5 that has received the request signal transmitted thereto performs predetermined logical computation on the received first challenge code to create a second challenge code that is required for the on-board device 1 to authenticate the portable device 5, and transmits a response signal that includes the second challenge code to the on-board device 1 using the portable transmission unit 53 (step S18).

The on-board device 1 that has transmitted request signals in step S16 determines whether or not a response signal transmitted from the portable device 5 has been received by the on-board reception unit 13 within a predetermined waiting period (step S19). Upon determining that the response signal has not been received (step S19: NO), the control unit 11 returns processing to step S11. Upon determining that the response signal has been received (step S19: YES), the control unit 11 performs authentication of the portable device 5 based on the second challenge code included in the response signal, and determines whether or not the authentication is successful (step S20). Specifically, the control unit 11 performs authentication of the portable device 5 by determining whether or not the code obtained by performing logical computation on the first challenge code transmitted in step S16, using an algorithm that is similar to the algorithm applied to the portable device 5, matches the second challenge code transmitted from the portable device 5. Upon determining that the authentication is unsuccessful (step S20: NO), the control unit 11 returns processing to step S19. Upon determining that that the authentication is successful (step S20: YES), the control unit 11 transmits lighting control signals to the external vehicle illumination units 6 to turn on the external vehicle illumination units 6 (step S21), and terminates processing.

Note that the external vehicle illumination units 6 continuously light up until a predetermined period of time has elapsed or a door of the vehicle C is opened. Upon terminating the processing performed to light up the external vehicle illumination units 6, the on-board device 1 executes the processing shown in FIG. 5 again.

### Portable Device Position Measurement

Although the example above illustrates a case in which the signal transmission method according to the present disclosure is applied to the welcome light function, the signal transmission method is also applicable to communication processing that is performed to detect the position of the portable device 5. In position detection processing, processing that is performed to transmit wake-up signals to the portable device 5 to activate the portable device 5 is the same as the processing performed from steps S11 to S15. Upon activating the portable device 5, the on-board device 1 selects a pair of antennas that are adjacent to each other in the front-rear direction or the left-right direction relative to the travelling direction of the vehicle C from among the first to fourth LF transmission antennas 14a, 14b, 14c, and 14d, and substantially simultaneously transmits the same detection signals from the pair of antennas selected from among the first to fourth LF transmission antennas 14a, 14b, 14c, and 14d. The on-board device 1 switches the pair of antennas that are to be used, from among the first to fourth LF transmission antennas 14a, 14b, 14c, and 14d, and transmits the detection signals in the same manner. The portable device 5 receives detection signals transmitted from each pair selected from among the first to fourth LF transmission antennas 14a, 14b, 14c, and 14d, and measures the received signal strength of each received detection signal. Then, the portable device 5 transmits a response signal that includes the received signal strengths measured and obtained, to the on-board device 1. The on-board device 1 receives the response signal transmitted from the portable device 5, and detects the position of the portable device 5 based on the received signal strengths included in the response signal. The on-board device 1 that has detected the position of the portable device 5 executes the required processing corresponding to the position of the portable device 5.

### Effects of Signal Transmission Method According to Present Embodiment

Next, the following describes effects of the signal transmission method performed by the on-board device 1 according to the present embodiment.

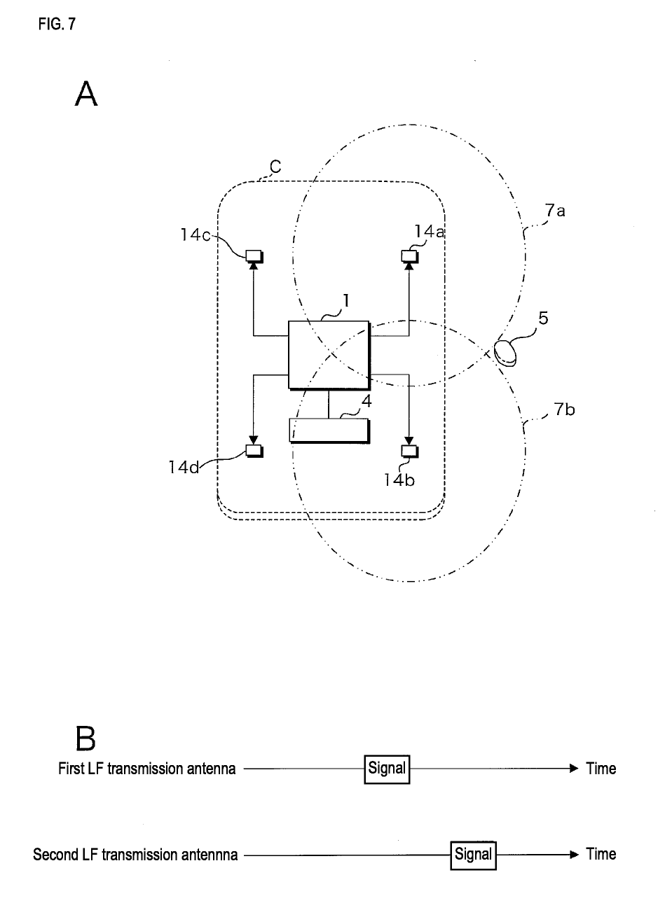

FIG. 6 is a conceptual diagram showing a transmission range of signals that are transmitted from the on-board device 1 according to the present embodiment, and FIG. 7 is a conceptual diagram showing a transmission range of signals that are transmitted from an on-board device 1 according to a comparative example. Part A in FIG. 6 conceptually shows transmission ranges 7a, 7b, and lab of signals that are transmitted from the first LF transmission antenna 14a and the second LF transmission antenna 14b according to the present embodiment. Part B in FIG. 6 is a timing chart of signals that are transmitted from the first LF transmission antenna 14a and the second LF transmission antenna 14b according to the present embodiment. The horizontal axis indicates time, and each “SIGNAL” enclosed in a square indicates the timing of transmitting the signal.

Similarly, Part A in FIG. 7 shows transmission ranges 7a and 7b of signals that are transmitted from the first LF transmission antenna 14a and the second LF transmission antenna 14b according to a conventional control method. Part B in FIG. 7 is a timing chart of signals that are transmitted from the first LF transmission antenna 14a and the second LF transmission antenna 14b according to a conventional control method.

As shown in Parts A and B in FIG. 7, the transmission range 7a of a signal that is transmitted from the individual first LF transmission antenna 14a according to a conventional control method is limited to a predetermined range that has a substantially spherical shape centered around the first LF transmission antenna 14a. Similarly, the transmission range 7b of a signal that is transmitted from the individual second LF transmission antenna 14b is limited to a predetermined range that has a substantially spherical shape centered around the second LF transmission antenna 14b. Therefore, the signal strength at a midpoint in the front-rear direction of the vehicle C relative to the travelling direction is weak, and the portable device 5 when located at the position shown in Part A in FIG. 7 cannot receive signals transmitted from the first and second LF transmission antennas 14a and 14b.

In contrast, as shown in Parts A and B in FIG. 6, the transmission range 7ab of signals that are substantially simultaneously transmitted from the first and second LF transmission antennas 14a and 14b is larger than the transmission ranges 7a and 7b of signals that are transmitted from the individual first and second LF transmission antennas 14a and 14b. Since the signals transmitted from the first and second LF transmission antennas 14a and 14b are in the LF band, the amplitudes of the signals around the vehicle C are uniform, and the signals respectively transmitted from the first and second LF transmission antennas 14a and 14b are superimposed on each other without interfering with or cancelling out each other, and thus the amplitudes are increased.

Similarly, although not shown in the figures, the same signals are substantially simultaneously transmitted from the third and fourth LF transmission antennas 14c and 14d that are separately located at front and rear positions of the vehicle C relative to the travelling direction, and thus the transmission range of signals on the left side of the vehicle C can be expanded.

Also, the same signals are substantially simultaneously transmitted from the first and third LF transmission antennas 14a and 14c that are separately located at left-front and right-front positions of the vehicle C, and thus the transmission range of signals around a front portion of the vehicle C can be expanded.

Furthermore, the same signals are substantially simultaneously transmitted from the second and fourth LF transmission antennas 14b and 14d that are separately located at left rear and right rear positions of the vehicle C, and thus the transmission range of signals around a rear portion of the vehicle C can be expanded.

### Experimental Results

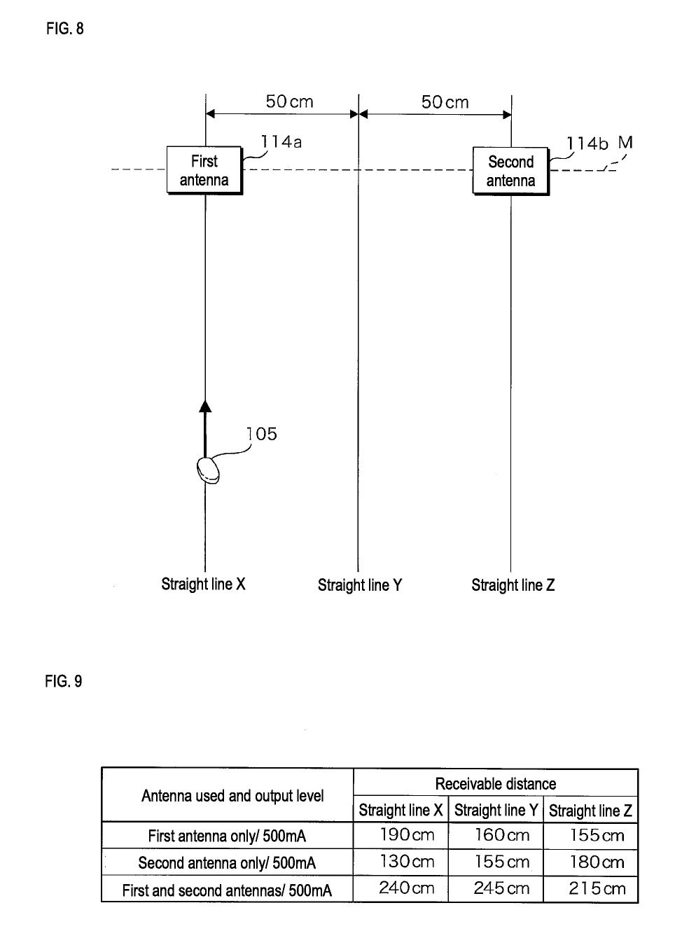

FIG. 8 is a conceptual diagram showing an experimental measurement system. A first antenna 114a and a second antenna 114b that can transmit signals that have a predetermined strength using radio waves in the LF band are separately located at a distance of 1 m. The first antenna 114a and the second antenna 114b respectively correspond to the first LF transmission antenna 14a and the second LF transmission antenna 14b. Each of the first and second antennas 114a and 114b includes a rod-shaped magnetic core that is made of ferrite, and a coil that is wound around the outer circumferential surface of the magnetic core. Capacitors are respectively connected to the coils so as to form resonant circuits. Also, a measurement reception device 105 that receives signals transmitted from the first and second antennas 114a and 114b is prepared. The measurement reception device 105 corresponds to the portable device 5. The measurement reception device 105 has an LED that lights up upon receiving a signal that has a strength no lower than a predetermined strength.

Using the experimental measurement system that has a configuration, positions at which the measurement reception device 105 can receive a signal that has a predetermined strength were measured when a current of 500 mA was fed to only the first antenna 114a, when a current of 500 mA was fed to only the second antenna 114b, and when a current of 500 mA was fed to both the first and second antennas 114a and 114b.

Specifically, a straight line X that passes through the first antenna 114a, a straight line Z that passes through the second antenna 114b, and a straight line Y between the straight lines X and Z, which are all horizontal straight lines that are orthogonal to the direction in which the first antenna 114a and the second antenna 114b are separated from each other, are defined.

Then, the measurement reception device 105 was arranged on the straight line X at a position where the LED lamp did not light up, and the measurement reception device 105 was moved toward the first antenna 114a. The position at which the LED of the measurement reception device 105 lit up was recorded as a position at which the measurement reception device 105 received a signal that had a predetermined strength. This position was defined by a distance between the position of the measurement reception device 105 at which the measurement reception device 105 received a signal that has a predetermined strength, and a reference line M that passes through the first and second antennas 114a and 114b, where the position of the reference line M was defined to be “0”. That is, the limit position reachable by signals transmitted from the first and second antennas 114a and 114b was recorded. Similarly, the measurement reception device 105 was arranged on the straight line Y and on the straight line Z, was moved toward the first and second antennas 114a and 114b, and the positions at which the LED of the measurement reception device 105 lit up were recorded.

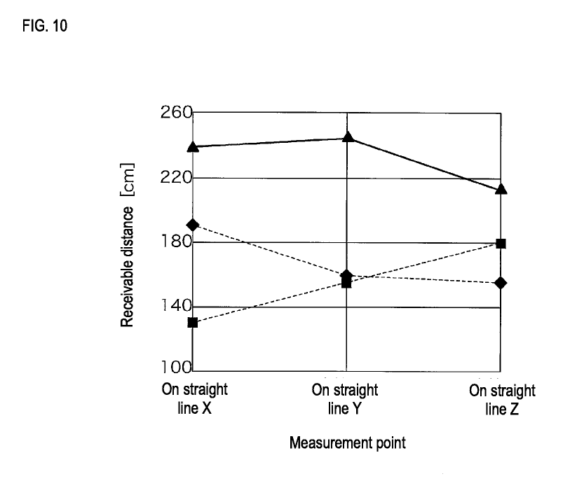

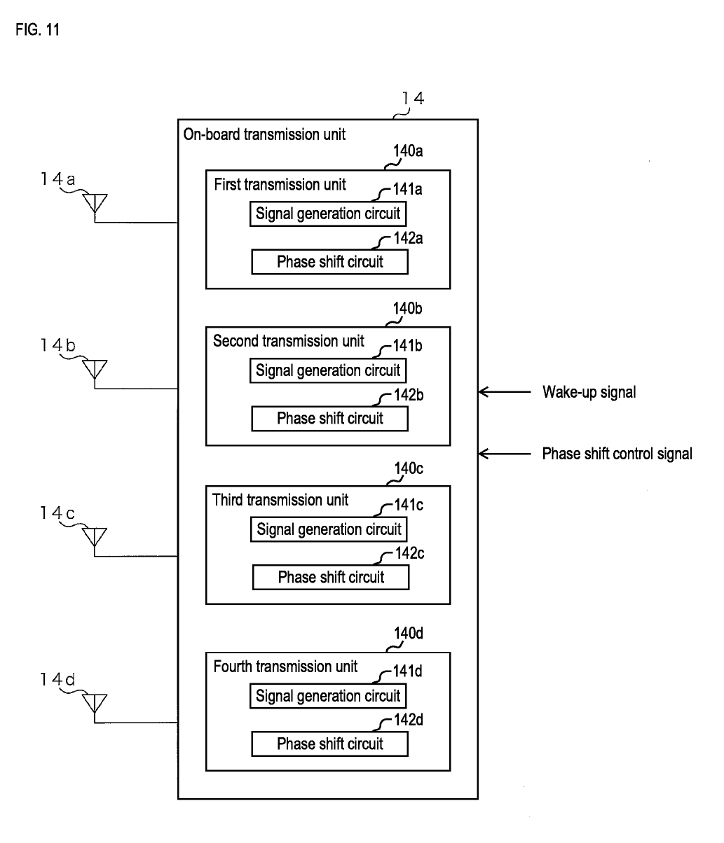

FIG. 9 is a chart showing the results of measurement, and FIG. 10 is a graph showing the results of measurement. FIG. 9 shows the positions at which the measurement reception device 105 received a signal that had a predetermined strength on the straight line X, the straight line Y, and the straight line Z in the cases where only the first antenna 114a transmits signals, only the second antenna 114b transmits signals, and both the first and second antennas 114a and 114b transmit signals. FIG. 10 is a graph representing the results of measurement shown in FIG. 9. In FIG. 10, the horizontal axis indicates positions on the straight line X, the straight line Y, and the straight line Z, and the vertical axis shows positions at which the LED of the measurement reception device 105 lit up, i.e., positions at which the measurement reception device 105 received a signal that had a predetermined strength. In other words, the vertical axis indicates limit positions at which the measurement reception device 105 can receive a signal that has a strength no lower than a predetermined strength. The graph plotted using triangle marks shows the results in the case in which signals were transmitted from both the first and second antennas 114a and 114b. The graph plotted using diamond marks shows the results in the case where signals were transmitted from the first antenna 114a, and the graph plotted using squares shows the results in the case where signals were transmitted from the second antenna 114b.

As can be seen from the graph shown in FIG. 10, if signals are transmitted only using the first antenna 114a or the second antenna 114b, the signals can reach a distance of only approximately 160 cm from the reference line M, especially on the straight line Y. Even on the straight line X and on the straight line Z, signals can reach a distance of approximately 180 cm to approximately 190 cm from the reference line M.

In contrast, when signals are transmitted from both the first and second antennas 114a and 114b, the signals reach a distance of approximately 250 cm or longer from the reference line M especially on the straight line Y, and thus the transmission range of signals is largely expanded. Even on the straight line X and on the straight line Z, the signals reach distances of approximately 240 cm and approximately 215 cm from the reference line M, and thus the transmission range of signals is expanded.

The on-board device 1 and the vehicle communication system with the above-described configurations can expand the transmission range of signals that are transmitted from the first to fourth LF transmission antennas 14a, 14b, 14c, and 14d of the on-board device 1.

Also, it is possible to expand the transmission range of signals on the right side of the vehicle C by substantially simultaneously transmitting the same signals from the first and second LF transmission antennas 14a and 14b that are separately located at front and rear positions of the vehicle C relative to the travelling direction. Similarly, it is possible to expand the transmission range of signals on the front, rear, left, and right sides of the vehicle C relative to the travelling direction.

In particular, the present embodiment can expand the transmission range of wake-up signals that are used to activate the portable device 5. Therefore, in the welcome light system, it is possible to more swiftly detect the portable device 5 approaching the vehicle C, and to light up the external vehicle illumination units 6.

It is also possible to expand the transmission range of detection signals that are used to detect the position of the portable device 5, and thus it is possible to detect the position of the portable device 5 that is more distant from the vehicle C.

Furthermore, the present embodiment uses the first to fourth LF transmission antennas 14a, 14b, 14c, and 14d that constitute the tire pressure monitoring system to detect the portable device 5 that is located in the vicinity of the vehicle C, and light up the external vehicle illumination units 6.

The present embodiment describes a configuration in which the welcome light function is realized using the first to fourth LF transmission antennas 14a, 14b, 14c, and 14d that constitute the tire pressure monitoring system. However, as a matter of course, the welcome light function may be realized using LF transmission antennas that constitute Smart Entry (registered trademark) or any other system.

In addition, although the present embodiment describes an example in which the same signals are substantially simultaneously transmitted from mainly two LF antennas, it is possible to employ a configuration in which the same signals are substantially simultaneously transmitted from three or more LF antennas.

Furthermore, although an example in which the present disclosure is applied to a system that mainly realizes a welcome light function has been described, purposes for which the present disclosure can be applied are not particularly limited. The present disclosure may be applied to Walk Away Close function, Smart Entry (registered trademark) function, and any other systems that require communication with the portable device 5.

Moreover, although the present embodiment describes an example in which the on-board device 1 transmits signals using radio waves in the LF band, the frequencies of signals are not particularly limited as long as signals transmitted from two LF transmission antennas interfere with or cancel out each other in the range where the on-board device 1 is required to communicate with the portable device 5.

### Second Embodiment

The second embodiment describes a configuration in which control is performed so that signals that are in antiphase are substantially simultaneously transmitted from two LF antennas.

FIG. 11 is a block diagram illustrating an example of a configuration of an on-board transmission unit 14 according to a second embodiment. The on-board transmission unit 14 includes first to fourth transmission units 140a, 140b, 140c, and 140d that respectively generate signals in the LF band that are to be transmitted from the first to fourth LF transmission antennas 14a, 14b, 14c, and 14d. In the second embodiment, each of the first to fourth LF transmission antennas 14a, 14b, 14c, and 14d includes: a rod-shaped magnetic core that is made of ferrite; and a coil that is wound around the magnetic core, and the coils are wound around the magnetic cores in the same direction.

The first transmission unit 140a includes a signal generation circuit 141a and a phase shift circuit 142a. The signal generation circuit 141a superimposes the signal wave of a signal (e.g. a wake-up signal) input from the control unit 11 onto a carrier wave (a carrier) to modulate the signal into a signal in the LF band. Note that the carrier wave is generated by an RC oscillation circuit, a crystal oscillation circuit, or the like (not shown). The signal wave modulated by the signal generation circuit 141a (the modulated wave) is input to the phase shift circuit 142a. The phase shift circuit 142a controls the phase of the input signal wave (modulated wave) based on a phase shift control signal that is input from the control unit 11, for example. The first transmission unit 140a transmits the signal wave, which has been subjected to phase control performed by the phase shift circuit 142a, to the outside via the first LF transmission antenna 14a.

The configurations of the second to fourth transmission units 140b, 140c, and 140d are the same as the configuration of the first transmission unit 140a. That is, the second transmission unit 140b includes a signal generation circuit 141b and a phase shift circuit 142b, the third transmission unit 140c includes a signal generation circuit 141c and a phase shift circuit 142c, and the fourth transmission unit 140d includes a signal generation circuit 141d and a phase shift circuit 142d. Each of the second to fourth transmission units 140b, 140c, and 140d superimposes the signal wave of a signal (e.g. a wake-up signal) input from the control unit 11 onto a carrier wave to modulate the signal into a signal in the LF band, thereafter controls the phase based on a phase shift control signal that is input from the control unit 11, and transmits the signal wave, which has been subjected to phase control, to the outside via the second to fourth LF transmission antennas 14b, 14c, and 14d.

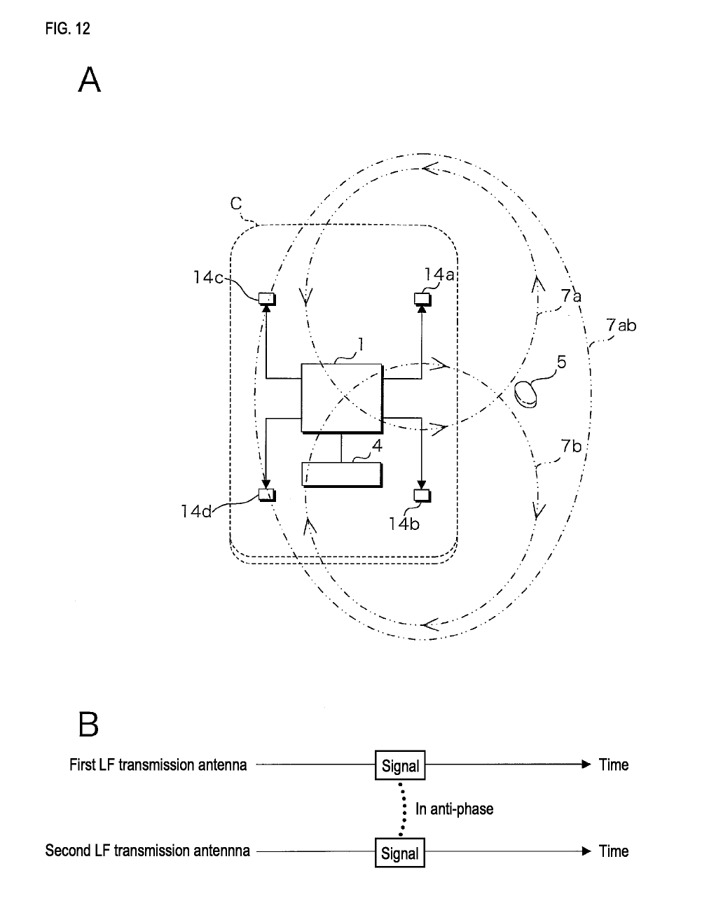

FIG. 12 is a conceptual diagram showing a transmission range of signals that are transmitted from an on-board device 1 according to the second embodiment. Part A in FIG. 12 conceptually shows transmission ranges 7a, 7b, and lab of signals that are transmitted from the first LF transmission antenna 14a and the second LF transmission antenna 14b according to the second embodiment. Part B in FIG. 12 is a timing chart of signals that are transmitted from the first LF transmission antenna 14a and the second LF transmission antenna 14b according to the second embodiment. The horizontal axis indicates time, and each “SIGNAL” enclosed in a square indicates the timing of transmitting the signal.

In the second embodiment, the control unit 11 outputs phase shift control signals that respectively control the phases of signal waves, to the phase shift circuits 142a and 142b so that signal waves that are transmitted from the first LF transmission antenna 14a and the second LF transmission antenna 14b are in antiphase. The phase shift circuits 142a and 142b control the respective phases of the signal waves based on the phase shift control signals from the control unit 11, and output signal waves that have been subjected to phase control, thereby substantially simultaneously outputting signal waves that are in antiphase, from the first LF transmission antenna 14a and the second LF transmission antenna 14b.

As described in the first embodiment, the transmission range 7a of a signal when the first LF transmission antenna 14a is used alone is limited to a range that has a substantially spherical shape centered around the first LF transmission antenna 14a. Similarly, the transmission range 7b when the second LF transmission antenna 14b is used alone is limited to a range that has a substantially spherical shape centered around the second LF transmission antenna 14b.

In contrast, in the second embodiment, signal waves that are in antiphase are substantially simultaneously transmitted from the first LF transmission antenna 14a and the second LF transmission antenna 14b, and therefore the directions of the magnetic fields of the signal waves are the same in the vicinity of the central point in the direction in which the first LF transmission antenna 14a and the second LF transmission antenna 14b are separated from each other. As a result, signals transmitted from the first and second LF transmission antennas 14a and 14b are superimposed on each other without interfering with or cancelling out each other, and the transmission range lab that is determined by the combined magnetic fields expands in the left-right direction around a central portion of the vehicle C in the front-rear direction.

Similarly, although not shown in the figures, signal waves that are in antiphase are substantially simultaneously transmitted from the third and fourth LF transmission antennas 14c and 14d, and thus the transmission range of signal waves can be expanded in the left-right direction around a central portion of the vehicle C in the front-rear direction.

Also, signal waves that are in antiphase are substantially simultaneously transmitted from the first and third LF transmission antennas 14a and 14c, and thus the transmission range of signal waves can be expanded in the front-rear direction around the central point of a front portion of the vehicle C relative to the left-right direction.

Also, signal waves in antiphase are substantially simultaneously transmitted from the second and fourth LF transmission antennas 14b and 14d, and thus the transmission range of signal waves can be expanded in the front-rear direction around the central point of a rear portion of the vehicle in the left-right direction.

As described above, in the second embodiment, the transmission range of signal waves can be expanded around a central portion of the vehicle C in the front-rear direction or the left-right direction. Using such a configuration, by expanding the transmission range of wake-up signals that are used to activate the portable device 5, for example, it is possible to more swiftly detect the portable device 5 approaching the vehicle C, and light up the external vehicle illumination units 6 in a welcome light system. It is also possible to expand the transmission range of detection signals that are used to detect the position of the portable device 5, and thus it is possible to detect the position of the portable device 5 that is more distant from the vehicle C.

The second embodiment employs a configuration in which the coils that constitute the first to fourth LF transmission antennas 14a, 14b, 14c, and 14d are wound in the same direction, and therefore the transmission range is expanded by transmitting signal waves that are in antiphase. However, if the coils that constitute the first and second LF transmission antennas 14a and 14b are wound in opposite directions, it is possible to employ a configuration in which the transmission range is expanded by transmitting signal waves that are in phase, from the first and second LF transmission antennas 14a and 14b.

### Third Embodiment

The third embodiment describes a configuration in which control is performed so that signals that are in phase are substantially simultaneously transmitted from two LF antennas.

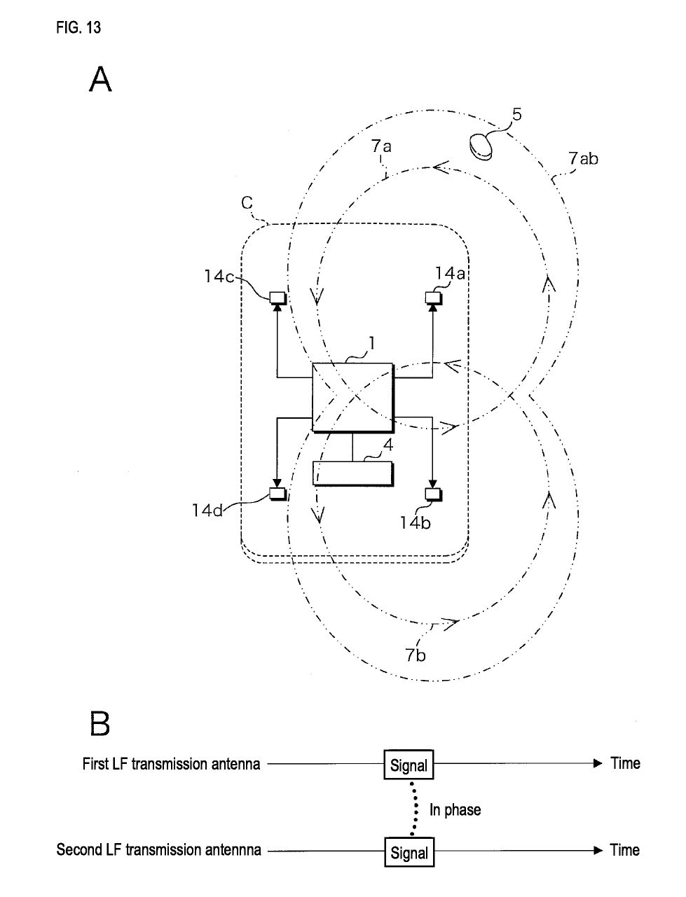

FIG. 13 is a conceptual diagram showing a transmission range of signals that are transmitted from an on-board device 1 according to the third embodiment. The internal configuration of the on-board device 1 according to the third embodiment is the same as that of the second embodiment. That is, the on-board transmission unit 14 of the on-board device 1 includes the first to fourth transmission units 140a, 140b, 140c, and 140d, generates signals in the LF band, which have been subjected to phase control using the first to fourth transmission units 140a, 140b, 140c, and 140d, and outputs the generated signals in the LF band to the outside as signal waves from the first to fourth LF transmission antennas 14a, 14b, 14c, and 14d. Each of the first to fourth LF transmission antennas 14a, 14b, 14c, and 14d includes: a rod-shaped magnetic core that is made of ferrite; and a coil that is wound around the magnetic core, and the coils are wound around the magnetic cores in the same direction.

In the third embodiment, the control unit 11 outputs phase shift control signals that respectively control the phases of signal waves, to the phase shift circuits 142a and 142b so that signal waves that are transmitted from the first LF transmission antenna 14a and the second LF transmission antenna 14b are in phase, for example. The phase shift circuits 142a and 142b control the respective phases of the signal waves based on the phase shift control signals from the control unit 11, and output signal waves that have been subjected to phase control, thereby substantially simultaneously outputting signal waves that are in phase, from the first LF transmission antenna 14a and the second LF transmission antenna 14b.

Part A in FIG. 13 conceptually shows transmission ranges 7a, 7b, and 7ab of signals that are transmitted from the first LF transmission antenna 14a and the second LF transmission antenna 14b according to the third embodiment. Part B in FIG. 13 is a timing chart of signals that are transmitted from the first LF transmission antenna 14a and the second LF transmission antenna 14b according to the third embodiment. The horizontal axis indicates time, and each “SIGNAL” enclosed in a square indicates the timing of transmitting the signal.

As described in the first embodiment, the transmission range 7a of a signal when the first LF transmission antenna 14a is used alone is limited to a range that has a substantially spherical shape centered around the first LF transmission antenna 14a. Similarly, the transmission range 7b when the second LF transmission antenna 14b is used alone is limited to a range that has a substantially spherical shape centered around the second LF transmission antenna 14b.

In contrast, in the third embodiment, signal waves that are in phase are substantially simultaneously transmitted from the first LF transmission antenna 14a and the second LF transmission antenna 14b, and therefore the directions of the magnetic fields of the signal waves are opposite to each other around the central point in the direction in which the first LF transmission antenna 14a and the second LF transmission antenna 14b are separated from each other, and the directions of the magnetic fields of the signal waves are the same around a front portion and a rear portion of the vehicle C. As a result, although signals transmitted from the first and second LF transmission antennas 14a and 14b become weak around a central portion of the vehicle C in the front-rear direction, the signals are superimposed on each other without interfering with or cancelling out each other, and the transmission range 7ab that is determined by the combined magnetic fields expands in the front-rear direction around a front portion and a rear portion of the vehicle C.

Similarly, although not shown in the figures, signal waves that are in phase are substantially simultaneously transmitted from the third and fourth LF transmission antennas 14c and 14d, and thus the transmission range of signal waves can be expanded in the front-rear direction around a front portion and a rear portion of the vehicle C.

Also, signal waves that are in phase are substantially simultaneously transmitted from the first and third LF transmission antennas 14a and 14c, and thus the transmission range of signal waves can be expanded in the left-right direction around a front portion of the vehicle C.

Furthermore, signal waves that are in phase are substantially simultaneously transmitted from the second and fourth LF transmission antennas 14b and 14d, and thus the transmission range of signal waves can be expanded in the left-right direction around a rear portion of the vehicle C.

As described above, in the third embodiment, the transmission range of signal waves can be expanded around a front portion and a rear portion of the vehicle C. Using such a configuration, by expanding the transmission range of wake-up signals that are used to activate the portable device 5, for example, it is possible to more swiftly detect the portable device 5 approaching the vehicle C, and light up the external vehicle illumination units 6 in a welcome light system. It is also possible to expand the transmission range of detection signals that are used to detect the position of the portable device 5, and thus it is possible to detect the position of the portable device 5 that is more distant from the vehicle C.

The third embodiment employs a configuration in which the coils that constitute the first to fourth LF transmission antennas 14a, 14b, 14c, and 14d are wound in the same direction, and therefore the transmission range is expanded by transmitting signal waves that are in phase. However, if the coils that constitute the first and second LF transmission antennas 14a and 14b are wound in opposite directions, it is possible to employ a configuration in which the transmission range is expanded by transmitting signal waves that are in antiphase, from the first and second LF transmission antennas 14a and 14b.

### Fourth Embodiment

The fourth embodiment describes a configuration in which signals that are substantially simultaneously transmitted from two LF antennas are alternatingly switched to signals that are in phase and signals that are in antiphase.

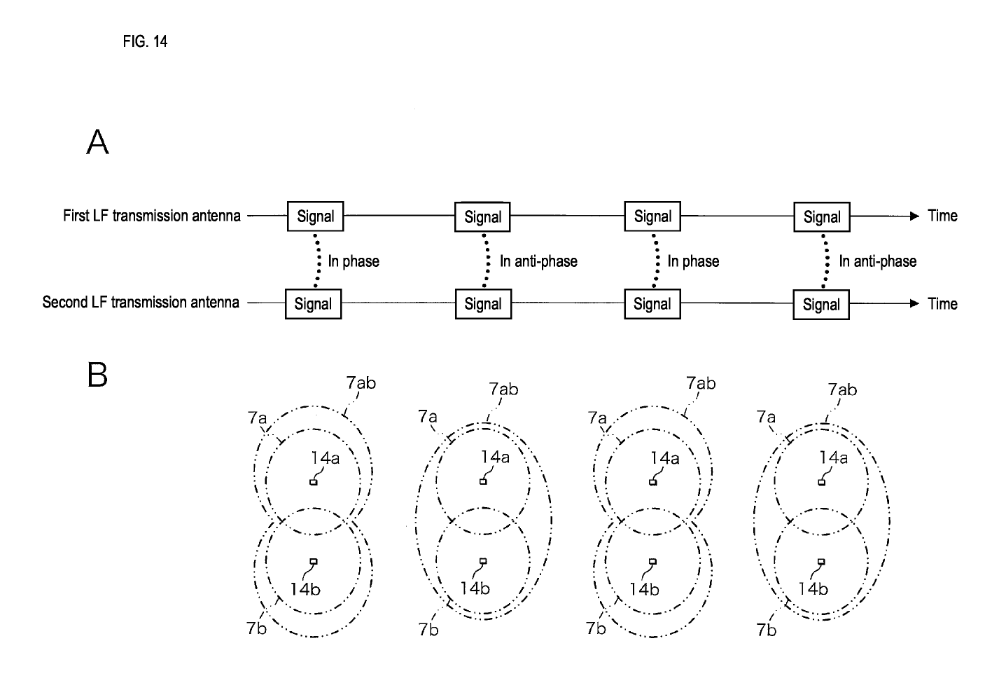

FIG. 14 is a conceptual diagram showing a transmission range of signals that are transmitted from an on-board device 1 according to the fourth embodiment. The internal configuration of the on-board device 1 according to the fourth embodiment is the same as that of the second embodiment. That is, the on-board transmission unit 14 of the on-board device 1 includes the first to fourth transmission units 140a, 140b, 140c, and 140d, generates signals in the LF band, which have been subjected to phase control using the first to fourth transmission units 140a, 140b, 140c, and 140d, and outputs the generated signals in the LF band to the outside as signal waves from the first to fourth LF transmission antennas 14a, 14b, 14c, and 14d.

In the fourth embodiment, the control unit 11 outputs phase shift control signals that respectively control the phases of signal waves, to the phase shift circuits 142a and 142b so that signal waves that are transmitted from the first LF transmission antenna 14a and the second LF transmission antenna 14b are alternatingly switched to signals that are in phase and signals that are in antiphase, for example. The phase shift circuits 142a and 142b control the respective phases of the signal waves based on the phase shift control signals from the control unit 11, and output signal waves that have been subjected to phase control, thereby alternatingly outputting signal waves that are in phase and signal waves that are in antiphase, from the first LF transmission antenna 14a and the second LF transmission antenna 14b. The period (time interval) of cycles in which signal waves that are in phase and signal waves that are in antiphase are switched is, for example 600 msec, but is not limited to 600 msec, and may be set as appropriate in view of the power consumption of the on-board device 1, the timing of detecting the portable device 5, and so on.

Part A in FIG. 14 is a timing chart of signals that are transmitted from the first LF transmission antenna 14a and the second LF transmission antenna 14b according to the fourth embodiment. The horizontal axis indicates time, and each “SIGNAL” enclosed in a square indicates the timing of transmitting the signal. Part B in FIG. 14 conceptually shows transmission ranges 7a, 7b, and 7ab of signals that are transmitted from the first LF transmission antenna 14a and the second LF transmission antenna 14b according to the fourth embodiment. Note that Part B in FIG. 14 only shows the positional relationship between the first LF transmission antenna 14a, the second LF transmission antenna 14b, and the transmission ranges 7a. 7b, and 7ab in a simplified manner.

As described in the first embodiment, the transmission range 7a of a signal when the first LF transmission antenna 14a is used alone is limited to a range that has a substantially spherical shape centered around the first LF transmission antenna 14a. Similarly, the transmission range 7b when the second LF transmission antenna 14b is used alone is limited to a range that has a substantially spherical shape centered around the second LF transmission antenna 14b.

In contrast, the fourth embodiment employs a configuration in which signal waves that are in phase and signal waves that are in antiphase are alternatingly transmitted from the first LF transmission antenna 14a and the second LF transmission antenna 14b. The transmission range 7ab of signal waves that are in phase expands in the front-rear direction around a front portion and a rear portion of the vehicle C, and the transmission range 7ab of signal waves that are in antiphase expands in the left-right direction around a central portion of the vehicle C.

Therefore, the fourth embodiment can expand the transmission range of signal waves, compared to the case in which signal waves in phase are used alone, and the case in which signal waves in antiphase are used alone. Using such a configuration, by expanding the transmission range of wake-up signals that are used to activate the portable device 5, for example, it is possible to more swiftly detect the portable device 5 approaching the vehicle C, and light up the external vehicle illumination units 6 in a welcome light system. It is also possible to expand the transmission range of detection signals that are used to detect the position of the portable device 5, and thus it is possible to detect the position of the portable device 5 that is more distant from the vehicle C.

The embodiments disclosed herein are examples in all respects, and are not to be construed as limiting. The scope of the present disclosure is defined by the claims rather than by the meaning of the description above, and all modifications equivalent to and within the scope of the claims are intended to be encompassed.

1. An on-board device that transmits signals to a portable device, from a plurality of transmission antennas that are provided for a vehicle at positions that are separate from each other, wherein the plurality of transmission antennas are respectively located at tire positions at which a plurality of tires of the vehicle are provided, the on-board device comprising:
a transmission unit that transmits the signals from the transmission antennas such that a transmission range in which the portable device can receive the signals is a range around the vehicle,
the transmission unit substantially simultaneously transmits the signals from two or more transmission antennas from among the transmission antennas, to expand the transmission range.

2. The on-board device according to claim 1, wherein signals in Low Frequency band are transmitted from the plurality of transmission antennas.

3. The on-board device according to claim 1,
wherein at least two transmission antennas from among the transmission antennas are located at positions that are separate from each other in a front-rear direction or a left-right direction relative to a travelling direction of the vehicle, and
the transmission unit substantially simultaneously transmits the signals from the two transmission antennas located at positions that are separate from each other in the front-rear direction or the left-right direction.

4. The on-board device according to claim 3, further comprising:
a phase control unit that controls phases of the signals that are substantially simultaneously transmitted from the two transmission antennas.

5. The on-board device according to claim 4,
wherein the phase control unit alternatingly switches the signals to signals that are in phase and signals that are in antiphase, and
signals that are in phase and signals that are in antiphase are alternatingly transmitted from the two transmission antennas.

6. The on-board device according to claim 1,
wherein the transmission unit substantially simultaneously transmits signals that are used to activate the portable device, from the two or more transmission antennas.

7. The on-board device according to claim 1,
wherein the transmission unit substantially simultaneously transmits signals that are related to detection of a position of the portable device, from the two or more transmission antennas.

8. The on-board device according to claim 1, wherein the transmission unit is provided for each of the plurality of tires, and the transmission units transmit the signals from the transmission antennas located at the tire positions, to a plurality of detection devices that wirelessly transmit air pressure signals obtained by detecting air pressure in the tires.

9. A vehicle communication system comprising:
the on-board device according to claim 1;
a plurality of transmission antennas that are provided for a vehicle at positions that are separate from each other; and
a portable device that receives the signals transmitted from the on-board device, and transmits a response signal corresponding to the signals thus received,
wherein the on-board device includes a reception unit that receives the response signal transmitted from the portable device, and executes processing corresponding to the response signal thus received.
